(19) United States
(12) Patent Application Publication
(10) Pub. No.: US 2024/0179562 A1
(43) Pub. Date: May 30, 2024

(54) INFORMATION PROCESSING METHOD AND APPARATUS, AND TERMINAL

(71) Applicant: VIVO MOBILE COMMUNICATION CO., LTD., Guangdong (CN)

(72) Inventor: Peng SUN, Guangdong (CN)

(21) Appl. No.: 18/432,895

(22) Filed: Feb. 5, 2024

Related U.S. Application Data
(63) Continuation of application No. PCT/CN2022/112114, filed on Aug. 12, 2022.

(30) Foreign Application Priority Data
Aug. 16, 2021 (CN) 202110939078.X

(51) Int. Cl. H04W 28/06; H04W 24/10; H04W 64/00

(52) U.S. Cl. CPC H04W 28/06; H04W 24/10; H04W 64/00

(57) ABSTRACT

This application discloses an information processing method and apparatus, and a terminal. The method in embodiments of this application includes: A terminal compresses first information in a preset compression manner, and reports compressed first information, where the first information includes at least one of the following: first target information; representation information of the first target information; measurement information corresponding to the first target information; neural network use information corresponding to the first target information; information indicating whether the first target information meets a first condition; value information corresponding to the first target information; and first target information that meets the first condition, where the first target information includes at least one of the following: position information of the terminal; first measurement quantity information; first event information; first identifier information; first transmission parameter information; application layer configuration information; and first configuration information.

### CROSS-REFERENCE TO RELATED APPLICATIONS

This application is a Bypass Continuation Application of PCT International Application No. PCT/CN2022/112114 filed on Aug. 12, 2022, which claims priority to Chinese Patent Application No. 202110939078.X, filed on Aug. 16, 2021 in China, which are incorporated herein by reference in their entireties.

### TECHNICAL FIELD

This application relates to the field of communication technologies, and in particular, to an information processing method and apparatus, and a terminal.

### BACKGROUND

Replacing modules in a system in related technologies with artificial intelligence (AI) or machine learning (ML) methods can effectively improve system performance. When AI or ML is used in wireless communication systems, a large amount of data needs to be collected for training and data obtained by training needs to be reported. Therefore, a large quantity of air interface overheads are required.

### SUMMARY

According to a first aspect, an information processing method is provided, including:

A terminal compresses first information in a preset compression manner, and reports compressed first information, where
the first information includes at least one of the following:
first target information;
representation information of the first target information;
measurement information corresponding to the first target information;
neural network use information corresponding to the first target information;
information indicating whether the first target information meets a first condition;
value information corresponding to the first target information; and
first target information that meets the first condition, where
the first target information includes at least one of the following:
position information of the terminal;
first measurement quantity information;
first event information;
first identifier information;
first transmission parameter information;
application layer configuration information; and
first configuration information.

According to a second aspect, an information processing apparatus is provided, including:
a first processing module, configured to: compress first information in a preset compression manner, and report compressed first information, where
the first information includes at least one of the following:
first target information;
representation information of the first target information;
measurement information corresponding to the first target information;
neural network use information corresponding to the first target information;
information indicating whether the first target information meets a first condition;
value information corresponding to the first target information; and
first target information that meets the first condition, where
the first target information includes at least one of the following:
position information of the terminal;
first measurement quantity information;
first event information;
first identifier information;
first transmission parameter information;
application layer configuration information; and
first configuration information.

According to a third aspect, a terminal is provided, where the terminal includes a processor, a memory, and a program or an instruction that is stored in the memory and that can run on the processor, where when the program or the instruction is executed by the processor, the steps of the method according to the first aspect are implemented.

According to a fourth aspect, a terminal is provided, including a processor and a communication interface, where the processor is configured to: compress first information in a preset compression manner, and report compressed first information, where
the first information includes at least one of the following:
first target information;
representation information of the first target information;
measurement information corresponding to the first target information;
neural network use information corresponding to the first target information;
information indicating whether the first target information meets a first condition;
value information corresponding to the first target information; and
first target information that meets the first condition, where
the first target information includes at least one of the following:
position information of the terminal;
first measurement quantity information;
first event information;
first identifier information;
first transmission parameter information;
application layer configuration information; and
first configuration information.

According to a fifth aspect, a readable storage medium is provided, where the readable storage medium stores a program or an instruction, and when the program or the instruction is executed by a processor, the steps of the method according to the first aspect are implemented.

According to a sixth aspect, a chip is provided, where the chip includes a processor and a communication interface, where the communication interface is coupled to the processor, and the processor is configured to run a program or an instruction to implement the method according to the first aspect.

According to a seventh aspect, a computer program/program product is provided, where the computer program/program product is stored in a storage medium, and the program/program product is executed by at least one processor to implement the steps of the method according to the first aspect.

### BRIEF DESCRIPTION OF DRAWINGS

FIG. 1 is a structural diagram of a communication system to which embodiments of this application can be applied;

FIG. 2 is a schematic flowchart of an information processing method according to an embodiment of this application;

FIG. 3 is a schematic diagram of a module of an information processing apparatus according to an embodiment of this application;

FIG. 4 is a structural block diagram of a communication device according to an embodiment of this application; and

FIG. 5 is a structural block diagram of a terminal according to an embodiment of this application.

### DESCRIPTION OF EMBODIMENTS

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that the technology described in the embodiments of this application is not limited to a long term evolution (LTE)/LTE-Advanced (LTE-A) system, and may also be used in other wireless communication systems such as code division multiple access (CDMA), time division multiple access (TDMA), frequency division multiple access (FDMA), orthogonal frequency division multiple access (OFDMA), single-carrier frequency-division multiple access (SC-FDMA) systems, and another system. The terms “system” and “network” in the embodiments of this application may be used interchangeably. The technologies described can be applied to both the systems and the radio technologies mentioned above as well as to other systems and radio technologies. A new radio (NR) system is described below for an illustration purpose, and the term NR is used in most of the descriptions, although these technologies can also be used in an application other than an NR system application, for example, a 6^{th} generation (6G) communication system.

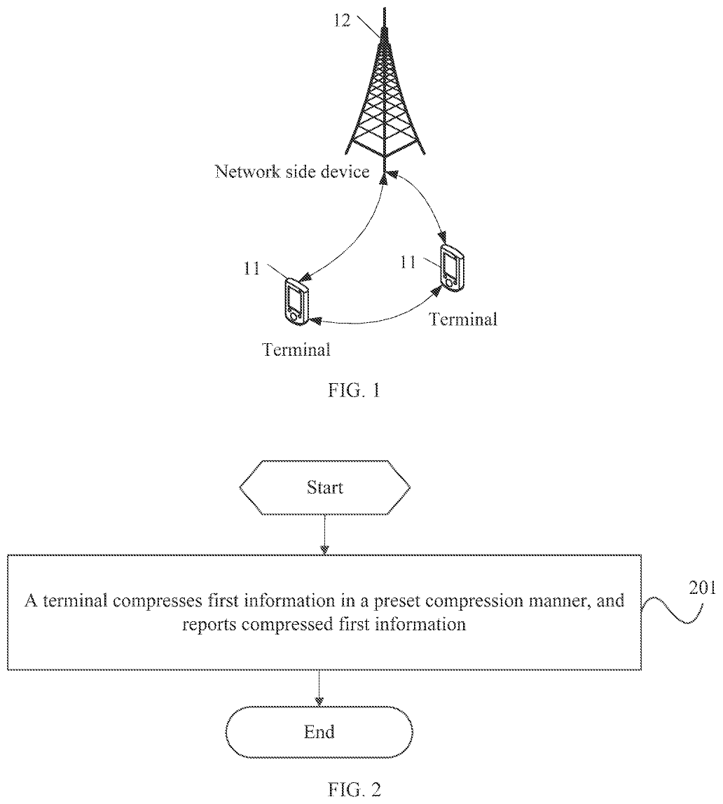

FIG. 1 is a structural diagram of a wireless communication system to which embodiments of this application can be applied. The wireless communication system includes a terminal 11 and a network side device 12. The terminal 11 may also be referred to as a terminal device or user equipment (UE). The terminal 11 may be a terminal side device such as a mobile phone, a tablet personal computer, a laptop computer (or referred to as a notebook computer), a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), or a smart home (a home device having a wireless communication function, such as a refrigerator, a television, a washing machine, or furniture). The wearable device includes: a smartwatch, a smart bracelet, a smart headphone, smart glasses, smart jewelry (a smart bangle, a smart bracelet, a smart ring, a smart necklace, a smart anklet, a smart ankle chain, and the like), a smart wristband, smart clothing, a game console, and the like. It should be noted that a specific type of the terminal 11 is not limited in the embodiments of this application. The network side device 12 may be a base station or a core network device. The base station may be referred to as a NodeB, an evolved NodeB, an access point, a base transceiver station (BTS), a radio base station, a radio transceiver, a basic service set (BSS), an extended service set (ESS), a NodeB, an evolved NodeB (Evolved NodeB, eNB), a home NodeB, a home evolved NodeB, a wireless local area network (WLAN) access point, a wireless fidelity (Wi-Fi) node, a transmitting receiving point (TRP), or another appropriate term in the art. Provided that a same technical effect is achieved, the base station is not limited to a specified technical term. It should be noted that, in the embodiments of this application, only a base station in an NR system is used as an example, but a specific type of the base station is not limited.

The following describes in detail the information processing method provided in the embodiments of this application through some embodiments and application scenarios thereof with reference to the accompanying drawings.

As shown in FIG. 2, an embodiment of this application provides an information processing method, including:

Step 201: A terminal compresses first information in a preset compression manner, and reports compressed first information, where
the first information includes at least one of the following:
first target information;
representation information of the first target information;
measurement information corresponding to the first target information;
neural network use information corresponding to the first target information;
information indicating whether the first target information meets a first condition;
value information corresponding to the first target information; and
first target information that meets the first condition, where
the first target information includes at least one of the following:
position information of the terminal;
first measurement quantity information;
first event information;
first identifier information;
first transmission parameter information;
application layer configuration information; and
first configuration information.

Herein, the foregoing first information is information related to data used for training.

Optionally, the first condition is configured by a network or is prescribed in advance.

Optionally, the preset compression manner is configured by a network or is prescribed in advance.

In the information processing method in this embodiment of this application, the terminal compresses the first information in the preset compression manner, and reports the compressed first information. The first information is information related to training data. In this way, the first information related to the training data is compressed in the preset compression manner and then reported, so that overheads of air interface signaling can be reduced.

Optionally, different second target information corresponds to different first conditions or different preset compression manners, and the second target information includes at least one of the following:
a cell;
a tracking area (TA);
a frequency;
a public land mobile network (PLMN);
connection information;
a quality of service (QOS) flow; and
a bandwidth part (BWP).

In this embodiment of this application, for different application scenarios, such as cell handover, TA area update, different frequencies, and different BWP scenarios, the terminal uses different first conditions and different compression manners.

The first conditions and compression manners corresponding to different application scenarios may be preconfigured, and when a corresponding event occurs, a corresponding condition and a corresponding compression manner are used according to the pre-configuration.

The first conditions and compression manners corresponding to different application scenarios and corresponding events are configured or activated by using same signaling. For example, a corresponding condition and compression method are configured by using cell handover signaling, and a corresponding condition and compression method are activated by using BWP activation signaling.

Optionally, the method in this embodiment of this application further includes:
in a case of changing the second target information, changing a corresponding first condition or preset compression manner.

Optionally, each piece of the second target information corresponds to at least one first condition or corresponds to at least one preset compression manner.

Optionally, configuration signaling of the first condition or the preset compression manner is the same as configuration signaling of the second target information.

Optionally, the representation information of the first information is indicated by information corresponding to a neutral network.

Optionally, reporting the compressed first information includes:
reporting the compressed first information according to a predefined cycle; or
triggering to report the compressed first information, according to a trigger condition, where
the trigger condition includes at least one of the following:
report indication information sent by a network is received;
a predefined event; and
an amount of the first information reaches a preset threshold.

Optionally, a report granularity of the first information includes at least one of the following:
each terminal;
each cell;
each frequency layer;
each BWP;
each transmit antenna port; and
each receive antenna port.

Optionally, compressing the first information in the preset compression manner by the terminal includes:

The terminal compresses the first information based on a first neural network; or
the terminal compresses the first information based on a large-scale parameter, for example, collects statistics on large-scale distribution information of a key parameter corresponding to information that meets the first condition (for example, multipath time domain probability distribution information), and uses information obtained by statistics collection as the compressed first information; or
the terminal compresses the first information by merging a plurality of parts of the first information; or
the terminal obtains statistical characteristics by performing mathematical operation on a plurality of parts of the first information, and reports the statistical characteristics; or
the terminal compresses the first information in a differential mode; or
the terminal compresses the first information according to a category of the first information; or
the terminal compresses the first information according to a priority of the first information; or
the terminal compresses the first information according to an association relationship between at least two pieces of first information.

Optionally, the differential mode includes at least one of the following:
performing differentiation according to time;
performing differentiation according to a position; and
performing differentiation according to a target parameter, where the target parameter includes at least one of: a tracking area TA, a frequency, a public land mobile network, connection information, and a quality of service flow QOS Flow, for example, performing differential compression on two different TAs or performing differential compression on two different pieces of connection information.

In this embodiment of this application, for example, only a small part of content is different in second information A and second information B. In this case, only a different part in the second information B may be compressed based on the second information A.

Optionally, compressing the first information according to the category of the first information by the terminal includes:
obtaining a category corresponding to each piece of the first information; and
selecting first information corresponding to a target category as the compressed first information.

Optionally, compressing the first information according to the priority of the first information by the terminal includes:
obtaining a priority corresponding to each piece of the first information; and
selecting first information with a priority higher than a preset priority as the compressed first information.

Optionally, an association relationship exists between at least two information types in the following information of the first information reported by the terminal:
time information;
measurement result information;
position information;
event information; and
channel characteristic information.

Optionally, the first condition includes at least one of the following:
a first position condition;
a first measurement quantity condition;
a first event condition;
a first identifier condition;
a first transmission parameter condition;
an application layer related condition; and
a first configuration condition.

In a first optional implementation, the first position condition includes:
a position of the terminal meets a first preset condition.

The position of the terminal includes at least one of the following:
a cell in which the terminal is located;
a tracking area (TA) in which the terminal is located;
a RAN-based notification area (RNA) in which the terminal is located;
a geographic position of the terminal; and
a timing advance (TA) indicated by a network for the terminal.

The first preset condition includes at least one of the following:
a specific representation of the terminal or the position of the terminal falls within a preconfigured range corresponding to a cell identifier;
a specific representation of the terminal or the position of the terminal falls within a preconfigured range corresponding to the tracking area;
a specific representation of the terminal or the position of the terminal falls within a preconfigured geographic position range;
a specific representation of the terminal or the position of the terminal falls within a preconfigured range corresponding to the RAN-based notification area (RNA); and
a specific representation of the terminal or the position of the terminal falls within a preconfigured range corresponding to the timing advance (TA).

In a second optional implementation, the first measurement quantity condition includes:
a first measurement quantity meets a second preset condition.

The first measurement quantity includes at least one of the following:
a signal value obtained at a receiving reference point or a statistical value of the signal value, where the signal value or the statistical value includes a channel estimated value obtained on a resource element (RE), for example, a channel estimation that is on each RE and that is obtained through measurement on a particular channel state information reference signal (CSI-RS), and the channel estimation is used as the first measurement quantity;
a signal-to-noise ratio (SNR);
a reference signal received power (RSRP);
a signal-to-noise and interference ratio (SINR);
reference signal received quality (RSRQ);
a packet delay;
a round-trip time (RTT);
an observed time difference of arrival (OTDOA);
a measurement result corresponding to channel state information (CSI);
a measurement result corresponding to a reference signal (RS);
a measurement result of radio resource management (RRM) measurement;
a measurement result of beam failure detection (BFD) measurement;
a measurement result of radio link failure (RLF) measurement;
a measurement result corresponding to reference signal (RS) measurement;
quality of experience (QoE) measurement information, where the QoE measurement information includes at least one of: a packet loss rate, service delay information, and a throughput; and
image information or image perception information, where the image information or the image perception information includes at least one of: information obtained by a camera and information obtained by a sensor.

Optionally, the measurement result corresponding to the first measurement quantity is obtained based on single measurement, or the measurement result corresponding to the first measurement quantity is obtained based on measurement for a plurality of times. For example, a plurality of measurement results are averaged or filtered after measurement is performed for a plurality of times, to obtain the measurement result corresponding to the first measurement quantity.

Optionally, a measurement resource corresponding to the first measurement quantity is preconfigured or prescribed in advance, where
the measurement resource corresponding to the first measurement quantity includes at least one of the following:
a physical downlink control channel (PDCCH) demodulation reference signal (DMRS);
a physical downlink shared channel (PDSCH) DMRS;
a channel state information reference signal (CSI-RS);
a synchronization signal/physical broadcast channel signal block (SSB);
a reference signal for BFD;
a reference signal for RRM;
a reference signal for RLF;
an identifier corresponding to the reference signal for BFD;
an identifier corresponding to the reference signal for RRM; and
an identifier corresponding to the reference signal for RLF.

The second preset condition includes at least one of the following:
the SNR or a specific representation of the SNR falls within a preconfigured range;
the RSRP or a specific representation of the RSRP falls within a preconfigured range;
the SINR or a specific representation of the SINR falls within a preconfigured range;
the RSRQ or a specific representation of the RSRQ falls within a preconfigured range;
the packet delay or a specific representation of the packet delay falls within a preconfigured range;
the RTT or a specific representation of the RTT falls within a preconfigured range;
the OTDOA or a specific representation of the OTDOA falls within a preconfigured range;
the measurement result corresponding to the CSI or a specific representation of the measurement result corresponding to the CSI falls within a preconfigured first measurement range;
the measurement result of the RRM measurement or a specific representation of the measurement result of the RRM measurement falls within a preconfigured range;
the measurement result of the BFD measurement or a specific representation of the measurement result of the BFD measurement falls within a preconfigured range;
the measurement result of the RLF measurement or a specific representation of the measurement result of the RLF measurement falls within a preconfigured range;
the measurement result corresponding to the RS measurement or a specific representation of the measurement result corresponding to the RS measurement falls within a preconfigured second measurement range; and
the measurement result corresponding to the QoE measurement information or a specific representation of the measurement result corresponding to the QoE measurement information falls within a preconfigured third measurement range.

Optionally, the radio resource management (RRM) measurement includes:
serving cell measurement;
neighboring cell measurement;
camping cell measurement; and
non-camping cell measurement.

In a third optional implementation, the first event condition includes:
a first event meets a third preset condition.

The first event includes at least one of the following:
a beam failure recovery (BFR) event;
a radio link failure (RLF) event;
radio resource management (RRM) measurement;
a handover event, for example, a cell handover event;
a measurement result event corresponding to BFR;
a measurement result event corresponding to RLF; and
an event that triggers the RRM measurement.

The third preset condition includes at least one of the following:
a measurement result corresponding to the BFR event or a specific representation corresponding to the BFR event falls within a preconfigured third measurement range;
a measurement result corresponding to the RLF event or a specific representation corresponding to the RLF event falls within a preconfigured fourth measurement range;
a measurement result corresponding to the RRM measurement or a specific representation corresponding to the RRM measurement falls within a preconfigured fifth measurement range; and
a measurement result corresponding to the handover event or a specific representation corresponding to the handover event falls within a preconfigured sixth measurement range.

The measurement result corresponding to the BFR event or the specific representation corresponding to the BFR event includes at least one of the following:
a beam failure detection reference signal based measurement result in BFR;
a new beam based measurement result in BFR; and
a measurement result based on a BFR event occurrence frequency.

The measurement result corresponding to the RLF event or the specific representation corresponding to the RLF event includes at least one of the following:
a serving cell based measurement result;
a neighboring cell based measurement result; and
a measurement result based on an RLF occurrence frequency.

The measurement result corresponding to the RRM measurement or the specific representation corresponding to the RRM measurement includes at least one of the following:
a measurement result corresponding to the serving cell;
a measurement result corresponding to the neighboring cell;
a measurement result corresponding to the camping cell; and
a measurement result corresponding to the non-camping cell.

The measurement result corresponding to the handover event or the specific representation corresponding to the handover event includes at least one of the following:
a TA corresponding to a source cell;
a TA corresponding to a target cell;
data interrupt duration;
a result of a difference between signal quality before handover and signal quality after handover;
a measurement quantity obtained in a handover process; and
a handover frequency.

In a fourth optional implementation, the first identifier condition includes:
a first identifier meets a fourth preset condition, where
the first identifier includes at least one of the following:
a cell identifier; and
a public land mobile network (PLMN) identifier.

The fourth preset condition includes at least one of the following:
the cell identifier is an identifier in a preconfigured cell identifier list; and
the PLMN identifier is an identifier in a preconfigured PLMN identifier list.

In a fifth optional implementation, the first transmission parameter condition includes:
a first transmission parameter meets a fifth preset condition, where
the first transmission parameter includes at least one of the following:
a channel characteristic parameter;
phase information between different transmit antennas or different transmit ports;
a measurement parameter obtained on one or more beams;
information corresponding to different beam pairs, where the beam pair includes a transmit beam and a receive beam;
a measurement parameter obtained on one or more frequencies;
data demodulation soft information;
a bit error rate or block error rate of data packet transmission, where the data packet includes one or more of the following: a physical layer data packet, a MAC layer data packet, an RLC layer data packet, a PDCP layer data packet, and an IP layer data packet; and
interference measurement information.

The fifth preset condition includes at least one of the following:
the channel characteristic parameter or a specific representation of the channel characteristic parameter falls within a preconfigured parameter range;
the beam measurement parameter or a specific representation of the beam measurement parameter falls within a preconfigured parameter range;
the phase information between different transmit antennas or different transmit ports or a specific representation of the phase information conforms to preconfigured phase information;
information corresponding to different receive beams or a specific representation of the information corresponding to different receive beams conforms to preconfigured first beam information;
the information corresponding to different beam pairs or a specific representation of the information corresponding to different beam pairs conforms to preconfigured second beam information;
the measurement parameter obtained on one or more frequencies falls within a preconfigured parameter range;
the data demodulation soft information or a specific representation of the data demodulation soft information conforms to preconfigured information;
the bit error rate of data packet transmission or a specific representation of the bit error rate of data packet transmission conforms to preconfigured information, where the data packet includes one or more of the following: a physical layer data packet, a medium access control (MAC) layer data packet, a radio link control (RLC) layer data packet, a packet data convergence protocol (PDCP) layer data packet, and an Internet Protocol (IP) layer data packet;
the block error rate or a specific representation of the block error rate conforms to preconfigured information; and
the interference measurement information or a specific representation of the interference measurement information conforms to preconfigured information.

In a sixth optional implementation, the application layer related condition includes:
the application layer configuration information meets a sixth preset condition.

In a seventh optional implementation, the first configuration condition includes:
a first configuration meets a seventh preset condition.

Optionally, the first configuration includes one or more of the following:
a configuration of reporting the specific first information; and
a configuration of content of the first information.

Optionally, the first condition further includes:
a manner of processing information corresponding to the first condition conforms to a preconfigured manner.

The information corresponding to the first condition includes one or more of the following:
the position of the terminal;
the first measurement quantity;
the first event;
the first identifier;
the first transmission parameter;
the application layer configuration information; and
the first configuration.

Optionally, before the terminal compresses the first information in the preset compression manner, the method further includes:
obtaining first indication information, where the first indication information is used to indicate index information corresponding to at least one of: the first condition and the preset compression manner; and
determining, according to the first indication information, at least one of: the first condition and the preset compression manner that correspond to the first indication information.

In this embodiment of this application, whether the first target information meets the first condition may be determined by using a second neural network.

This may specifically include: obtaining the second neural network, and determining, according to an output of the second neural network, whether the first target information meets the first condition.

The obtaining the second neural network includes:
obtaining neural network information sent by a first preset node, where the neural network information is used to indicate at least one neural network; and
determining, according to first indication information sent by a second preset node, the second neural network in the at least one neural network indicated by the neural network information.

The first preset node and the second preset node may be a same preset node, or may be different preset nodes.

The first preset node and a third preset node are different nodes, or the second preset node and the third preset node are different nodes, where
the third preset node is a node that sends the first condition to the terminal.

Optionally, the first preset node or the second preset node or the third preset node includes at least one of the following: a base station;
a location management function node;
a network data analytics function node;
an operation administration and management node; and
a core network predetermined node.

In this embodiment of this application, the terminal may exchange neural network related information (the neural network related information may be related information of one neural network, or related information of a plurality of neural networks, for example, related information of a neural network list) with a preset node (one or more). The neural network related information includes information such as a neural network parameter and a neural network structure.

Herein, the preset node that exchanges the neural network related information with the terminal and the preset node that exchanges the first condition with the terminal may be different nodes. For example, a preset node A exchanges a neural network set with the terminal, a preset node B exchanges the first condition with the terminal, and a preset node C controls a neural network used by the terminal. The preset node that exchanges the neural network related information with the terminal includes but is not limited to: a base station, a location management function (LMF) node, a network data analytics function (NWDAF) node, an operation administration and management (OAM) node, and another node of the core network.

Input information of the second neural network includes at least one of the following:
position information of the terminal;
first measurement quantity information;
first event information;
first identifier information;
first transmission parameter information;
application layer configuration information; and
first configuration information.

In this embodiment of this application, whether the first condition is met may be determined by using the second neural network. Specifically, correspondences between the second neural network and the foregoing input information may be preconfigured in different application scenarios. In a specific application scenario, corresponding input information is selected for input and there is no need to input all the information. For example, in a positioning scenario, the input information of the second neural network is configured as the position information of the terminal, so that the terminal may select only the position information of the terminal as the input information, so that signaling overheads can be effectively reduced. In addition, the first neural network and the second neural network may be a same neural network or different neural networks.

In the information processing method in this embodiment of this application, the terminal compresses the first information in the preset compression manner, and reports the compressed first information. The first information is information related to training data. In this way, the first information related to the training data is compressed in the preset compression manner and then reported, so that overheads of air interface signaling can be reduced.

It should be noted that, the information processing method provided in this embodiment of this application may be executed by an information processing apparatus, or a control module in the information processing apparatus for executing the information processing method. In the embodiments of this application, that the information processing apparatus performs the information processing method is used as an example to describe the information processing apparatus provided in the embodiments of this application.

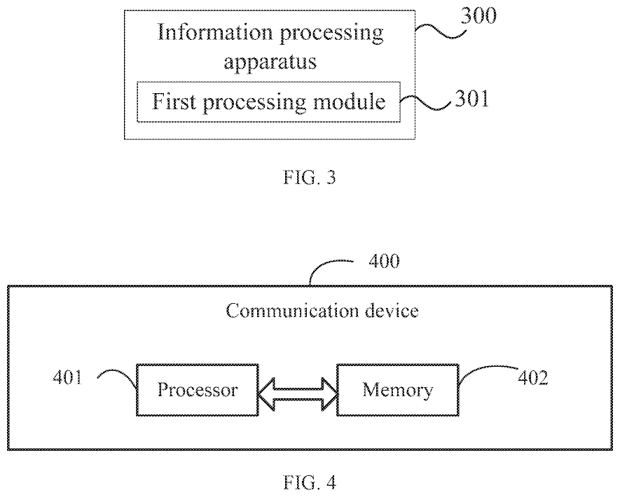

As shown in FIG. 3, an embodiment of this application further provides an information processing apparatus 300, including:
a first processing module 301, configured to: compress first information in a preset compression manner, and report compressed first information, where
the first information includes at least one of the following:
first target information;
representation information of the first target information;
measurement information corresponding to the first target information;
neural network use information corresponding to the first target information;
information indicating whether the first target information meets a first condition;
value information corresponding to the first target information; and
first target information that meets the first condition, where
the first target information includes at least one of the following:
position information of the terminal;
first measurement quantity information;
first event information;
first identifier information;
first transmission parameter information;
application layer configuration information; and
first configuration information.

Optionally, the apparatus in this embodiment of this application further includes:
a first determining module, configured to determine the preset compression manner.

Optionally, the representation information of the first information is indicated by information corresponding to a neutral network.

Optionally, the first processing module is configured to: report the compressed first information according to a predefined cycle; or
trigger to report the compressed first information, according to a trigger condition, where
the trigger condition includes at least one of the following:
report indication information sent by a network is received;
a predefined event; and
an amount of the first information reaches a preset threshold.

Optionally, a report granularity of the first information includes at least one of the following:
each terminal;
each cell;
each frequency layer;
each BWP;
each transmit antenna port; and
each receive antenna port.

Optionally, the first processing module is configured to: compress the first information based on a first neural network; or
compress the first information based on a large-scale parameter; or
compress the first information by merging a plurality of parts of the first information; or
obtain statistical characteristics by performing mathematical operation on a plurality of parts of the first information, and report the statistical characteristics; or
compress the first information in a differential mode; or
compress the first information according to a category of the first information; or
compress the first information according to a priority of the first information; or
compress the first information according to an association relationship between at least two pieces of first information.

Optionally, the differential mode includes at least one of the following:
performing differentiation according to time;
performing differentiation according to a position; and
performing differentiation according to a target parameter, where the target parameter includes at least one of: a tracking area (TA), a frequency, a public land mobile network, connection information, and a quality of service flow (QOS Flow).

Optionally, the first processing module includes:
a first obtaining submodule, configured to obtain a category corresponding to each piece of the first information; and
a first selection submodule, configured to select first information corresponding to a target category as the compressed first information.

Optionally, the first processing module includes:
a second obtaining submodule, configured to obtain a priority corresponding to each piece of the first information; and
a second selection submodule, configured to select first information with a priority higher than a preset priority as the compressed first information.

Optionally, an association relationship exists between at least two information types in the following information of the first information reported by the terminal:
time information;
measurement result information;
position information;
event information; and
channel characteristic information.

Optionally, the first condition includes at least one of the following:
a first position condition;
a first measurement quantity condition;
a first event condition;
a first identifier condition;
a first transmission parameter condition;
an application layer related condition; and
a first configuration condition.

Optionally, the first position condition includes:
a position of the terminal meets a first preset condition.

Optionally, the position of the terminal includes at least one of the following:
a cell in which the terminal is located;
a tracking area (TA) in which the terminal is located;
a RAN-based notification area in which the terminal is located;
a geographic position of the terminal; and
a timing advance (TA) indicated by a network for the terminal.

Optionally, the first preset condition includes at least one of the following:
a specific representation of the terminal or the position of the terminal falls within a preconfigured range corresponding to a cell identifier;
a specific representation of the terminal or the position of the terminal falls within a preconfigured range corresponding to the tracking area;
a specific representation of the terminal or the position of the terminal falls within a preconfigured geographic position range;
a specific representation of the terminal or the position of the terminal falls within a preconfigured range corresponding to the RAN-based notification area (RNA); and
a specific representation of the terminal or the position of the terminal falls within a preconfigured range corresponding to the timing advance (TA).

Optionally, the first measurement quantity condition includes:
a first measurement quantity meets a second preset condition.

Optionally, the first measurement quantity includes at least one of the following:
a signal value obtained at a receiving reference point or a statistical value of the signal value, where the signal value or the statistical value includes a channel estimated value obtained on an RE;
a signal-to-noise ratio (SNR);
a reference signal received power (RSRP);
a signal-to-noise and interference ratio (SINR);
reference signal received quality (RSRQ);
a packet delay;
a round-trip time (RTT);
an observed time difference of arrival (OTDOA);
a measurement result corresponding to channel state information (CSI);
a measurement result of radio resource management (RRM) measurement;
a measurement result of beam failure detection (BFD) measurement;
a measurement result of radio link failure (RLF) measurement;
a measurement result corresponding to reference signal (RS) measurement;
quality of experience (QoE) measurement information, where the QoE measurement information includes at least one of: a packet loss rate, service delay information, and a throughput; and image information or image perception information, where the image information or the image perception information includes at least one of: information obtained by a camera and information obtained by a sensor.

Optionally, the measurement result corresponding to the first measurement quantity is obtained based on single measurement, or the measurement result corresponding to the first measurement quantity is obtained based on measurement for a plurality of times.

Optionally, a measurement resource corresponding to the first measurement quantity is preconfigured or prescribed in advance, where
the measurement resource corresponding to the first measurement quantity includes at least one of the following:
a physical downlink control channel (PDCCH) demodulation reference signal (DMRS);
a physical downlink shared channel (PDSCH) DMRS;
a channel state information reference signal (CSI-RS);
a synchronization signal/physical broadcast channel signal block (SSB);
a reference signal for BFD;
a reference signal for RRM;
a reference signal for RLF;
an identifier corresponding to the reference signal for BFD;
an identifier corresponding to the reference signal for RRM; and
an identifier corresponding to the reference signal for RLF.

Optionally, the second preset condition includes at least one of the following:
the SNR or a specific representation of the SNR falls within a preconfigured range;
the RSRP or a specific representation of the RSRP falls within a preconfigured range;
the SINR or a specific representation of the SINR falls within a preconfigured range;
the RSRQ or a specific representation of the RSRQ falls within a preconfigured range;
the packet delay or a specific representation of the packet delay falls within a preconfigured range;
the RTT or a specific representation of the RTT falls within a preconfigured range;
the OTDOA or a specific representation of the OTDOA falls within a preconfigured range;
the measurement result corresponding to the CSI or a specific representation of the measurement result corresponding to the CSI falls within a preconfigured first measurement range;
the measurement result of the RRM measurement or a specific representation of the measurement result of the RRM measurement falls within a preconfigured range;
the measurement result of the BFD measurement or a specific representation of the measurement result of the BFD measurement falls within a preconfigured range;
the measurement result of the RLF measurement or a specific representation of the measurement result of the RLF measurement falls within a preconfigured range;
the measurement result corresponding to the RS measurement or a specific representation of the measurement result corresponding to the RS measurement falls within a preconfigured second measurement range; and
the measurement result corresponding to the QoE measurement information or a specific representation of the measurement result corresponding to the QoE measurement information falls within a preconfigured third measurement range.

Optionally, the radio resource management (RRM) measurement includes:
serving cell measurement;
neighboring cell measurement;
camping cell measurement; and
non-camping cell measurement.

Optionally, the first event condition includes:
a first event meets a third preset condition.

Optionally, the first event includes at least one of the following:
a beam failure recovery (BFR) event;
a radio link failure (RLF) event;
radio resource management (RRM) measurement;
a handover event;
a measurement result event corresponding to BFR;
a measurement result event corresponding to RLF; and
an event that triggers the RRM measurement.

Optionally, the third preset condition includes at least one of the following:
a measurement result corresponding to the BFR event or a specific representation corresponding to the BFR event falls within a preconfigured third measurement range;
a measurement result corresponding to the RLF event or a specific representation corresponding to the RLF event falls within a preconfigured fourth measurement range;
a measurement result corresponding to the RRM measurement or a specific representation corresponding to the RRM measurement falls within a preconfigured fifth measurement range; and
a measurement result corresponding to the handover event or a specific representation corresponding to the handover event falls within a preconfigured sixth measurement range.

Optionally, the measurement result corresponding to the BFR event or the specific representation corresponding to the BFR event includes at least one of the following:
a beam failure detection reference signal based measurement result in BFR;
a new beam based measurement result in BFR; and
a measurement result based on a BFR event occurrence frequency.

Optionally, the measurement result corresponding to the RLF event or the specific representation corresponding to the RLF event includes at least one of the following:
a serving cell based measurement result;
a neighboring cell based measurement result; and
a measurement result based on an RLF occurrence frequency.

Optionally, the measurement result corresponding to the RRM measurement or the specific representation corresponding to the RRM measurement includes at least one of the following:
a measurement result corresponding to the serving cell;
a measurement result corresponding to the neighboring cell;
a measurement result corresponding to the camping cell; and
a measurement result corresponding to the non-camping cell.

Optionally, the measurement result corresponding to the handover event or the specific representation corresponding to the handover event includes at least one of the following:
a TA corresponding to a source cell;
a TA corresponding to a target cell;
data interrupt duration;
a result of a difference between signal quality before handover and signal quality after handover;
a measurement quantity obtained in a handover process; and
a handover frequency.

Optionally, the first identifier condition includes:
a first identifier meets a fourth preset condition.

Optionally, the first identifier includes at least one of the following:
a cell identifier; and
a public land mobile network (PLMN) identifier.

Optionally, the fourth preset condition includes at least one of the following:
the cell identifier is an identifier in a preconfigured cell identifier list; and
the PLMN identifier is an identifier in a preconfigured PLMN identifier list.

Optionally, the first transmission parameter condition includes:
a first transmission parameter meets a fifth preset condition.

Optionally, the first transmission parameter includes at least one of the following:
a channel characteristic parameter;
phase information between different transmit antennas or different transmit ports;
a measurement parameter obtained on one or more beams;
information corresponding to different beam pairs, where the beam pair includes a transmit beam and a receive beam;
a measurement parameter obtained on one or more frequencies;
data demodulation soft information;
a bit error rate or block error rate of data packet transmission, where the data packet includes one or more of the following: a physical layer data packet, a MAC layer data packet, an RLC layer data packet, a PDCP layer data packet, and an IP layer data packet; and
interference measurement information.

Optionally, the fifth preset condition includes at least one of the following:
the channel characteristic parameter or a specific representation of the channel characteristic parameter falls within a preconfigured parameter range;
the beam measurement parameter or a specific representation of the beam measurement parameter falls within a preconfigured parameter range;
the phase information between different transmit antennas or different transmit ports or a specific representation of the phase information conforms to preconfigured phase information;
information corresponding to different receive beams or a specific representation of the information corresponding to different receive beams conforms to preconfigured first beam information;
the information corresponding to different beam pairs or a specific representation of the information corresponding to different beam pairs conforms to preconfigured second beam information;
the measurement parameter obtained on one or more frequencies falls within a preconfigured parameter range;
the data demodulation soft information or a specific representation of the data demodulation soft information conforms to preconfigured information;
the bit error rate of data packet transmission or a specific representation of the bit error rate of data packet transmission conforms to preconfigured information, where the data packet includes one or more of the following: a physical layer data packet, a MAC layer data packet, an RLC layer data packet, a PDCP layer data packet, and an IP layer data packet;
the block error rate or a specific representation of the block error rate conforms to preconfigured information; and
the interference measurement information or a specific representation of the interference measurement information conforms to preconfigured information.

Optionally, the application layer related condition includes:
the application layer configuration information meets a sixth preset condition.

Optionally, the first configuration condition includes:
a first configuration meets a seventh preset condition.

Optionally, the first configuration includes one or more of the following:
a configuration of reporting the specific first information; and
a configuration of content of the first information.

Optionally, the first condition further includes:
a manner of processing information corresponding to the first condition conforms to a preconfigured manner.

Optionally, the first condition is configured by a network or is prescribed in advance.

Optionally, the preset compression manner is configured by a network or is prescribed in advance.

Optionally, different second target information corresponds to different first conditions or different preset compression manners, and the second target information includes at least one of the following:
a cell;
a TA area;
a frequency;
a PLMN;
connection information;
a QoS flow; and
a bandwidth part (BWP).

Optionally, the apparatus in this embodiment of this application further includes:
a change module, configured to: in a case of changing the second target information, change a corresponding first condition or preset compression manner.

Optionally, each piece of the second target information corresponds to at least one first condition or corresponds to at least one preset compression manner.

Optionally, configuration signaling of the first condition or the preset compression manner is the same as configuration signaling of the second target information.

Optionally, the apparatus in this embodiment of this application further includes:
a first obtaining module, configured to: obtain first indication information before the first processing module compresses the first information in the preset compression manner, where the first indication information is used to indicate index information corresponding to at least one of: the first condition and the preset compression manner; and
a second determining module, configured to determine, according to the first indication information, at least one of: the first condition and the preset compression manner that correspond to the first indication information.

In this embodiment of this application, the terminal compresses the first information in the preset compression manner, and reports the compressed first information. The first information is information related to training data. In this way, the first information related to the training data is compressed in the preset compression manner and then reported, so that overheads of air interface signaling can be reduced.

The information processing apparatus in this embodiment of this application may be an apparatus or an apparatus or electronic device with an operating system, or may be a component, an integrated circuit, or a chip in a terminal. The apparatus or electronic device may be a mobile terminal, or a non-mobile terminal. For example, the mobile terminal may include but is not limited to the foregoing listed types of the terminal 11, and the non-mobile terminal may be a server, a network attached storage (NAS), a personal computer (PC), a television (TV), a teller machine, or a self-service machine. This is not specifically limited in this embodiment of this application.

The apparatus provided in this embodiment of this application can implement the processes implemented in the method embodiment of FIG. 2 and achieve a same technical effect. To avoid repetition, details are not described herein again.

Optionally, as shown in FIG. 4, an embodiment of this application further provides a communication device 400, including a processor 401, a memory 402, a program or an instruction that is stored in the memory 402 and that can run on the processor 401. For example, when the communication device 400 is a terminal, the program or the instruction is executed by the processor 401 to implement processes of the embodiment of the foregoing information processing method applied to the terminal, with the same technical effect achieved. To avoid repetition, details are not described herein again.

An embodiment of this application further provides a terminal, including a processor and a communication interface, where the processor is configured to: compress first information in a preset compression manner, and report compressed first information, where
the first information includes at least one of the following:
first target information;
representation information of the first target information;
measurement information corresponding to the first target information;
neural network use information corresponding to the first target information;
information indicating whether the first target information meets a first condition;
value information corresponding to the first target information; and
first target information that meets the first condition, where
the first target information includes at least one of the following:
position information of the terminal;
first measurement quantity information;
first event information;
first identifier information;
first transmission parameter information;
application layer configuration information; and
first configuration information.

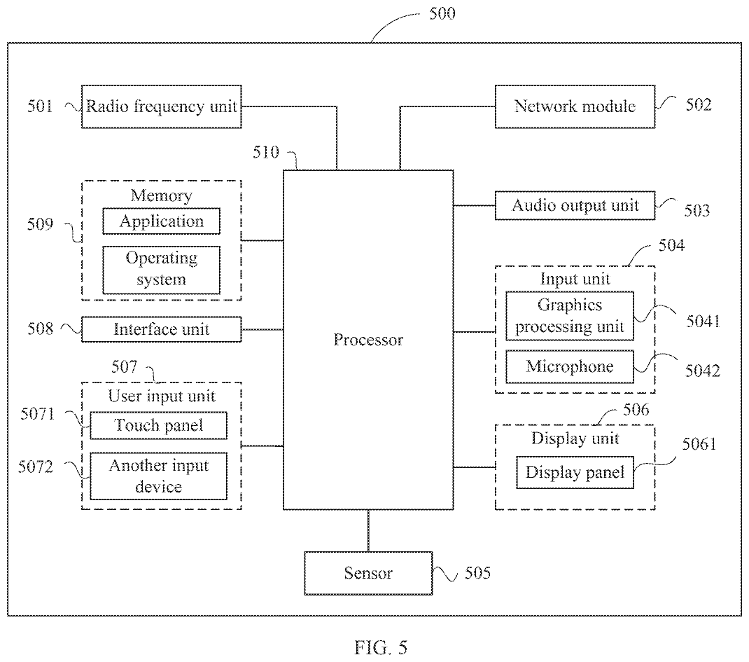

This terminal embodiment corresponds to the foregoing method embodiment on the terminal side. Each implementation process and implementation of the foregoing method embodiment may be applicable to this terminal embodiment, and a same technical effect can be achieved. Specifically, FIG. 5 is a schematic diagram of a hardware structure of a terminal according to an embodiment of this application. A terminal 500 includes but is not limited to at least some components in the following: a radio frequency unit 501, a network module 502, an audio output unit 503, an input unit 504, a sensor 505, a display unit 506, a user input unit 507, an interface unit 508, a memory 509, a processor 510, and the like.

A person skilled in the art may understand that the terminal 500 may further include a power supply (such as a battery) that supplies power to each component. The power supply may be logically connected to the processor 510 through a power management system, to implement functions such as charging and discharging management, and power consumption management by using the power management system. The terminal structure shown in FIG. 5 constitutes no limitation on the terminal, and the terminal may include more or fewer components than those shown in the figure, or combine some components, or have different component arrangements. Details are not described herein.

It should be understood that, in this embodiment of this application, the input unit 504 may include a graphics processing unit (GPU) 5041 and a microphone 5042, and the graphics processing unit 5041 processes image data of a still picture or a video obtained by an image capture apparatus (such as a camera) in a video capture mode or an image capture mode. The display unit 506 may include a display panel 5061. The display panel 5061 may be configured in a form such as a liquid crystal display or an organic light-emitting diode. The user input unit 507 includes a touch panel 5071 and another input device 5072. The touch panel 5071 is also referred to as a touchscreen. The touch panel 5071 may include two parts: a touch detection apparatus and a touch controller. The another input device 5072 may include but is not limited to a physical keyboard, a functional button (such as a volume control button or a power on/off button), a trackball, a mouse, and a joystick. Details are not described herein.

In this embodiment of this application, the radio frequency unit 501 receives downlink data from a network side device and then sends the downlink data to the processor 510 for processing; and sends uplink data to the network side device. Usually, the radio frequency unit 501 includes but is not limited to an antenna, at least one amplifier, a transceiver, a coupler, a low noise amplifier, a duplexer, and the like.

The memory 509 may be configured to store a software program or an instruction and various data. The memory 509 may mainly include a program or instruction storage area and a data storage area. The program or instruction storage area may store an operating system, an application or an instruction required by at least one function (for example, a sound playing function or an image playing function), and the like. In addition, the memory 509 may include a high-speed random access memory, and may further include a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory, for example, at least one disk storage device, a flash memory, or another non-volatile solid-state storage device.

The processor 510 may include one or more processing units. Optionally, an application processor and a modem processor may be integrated into the processor 510. The application processor mainly processes an operating system, a user interface, an application, an instruction, or the like. The modem processor mainly processes wireless communication, for example, a baseband processor. It may be understood that, alternatively, the modem processor may not be integrated into the processor 510.

The processor 510 is configured to: compress first information in a preset compression manner, and report compressed first information, where
the first information includes at least one of the following:
first target information;
representation information of the first target information;
measurement information corresponding to the first target information;
neural network use information corresponding to the first target information;
information indicating whether the first target information meets a first condition;
value information corresponding to the first target information; and
first target information that meets the first condition, where
the first target information includes at least one of the following:
position information of the terminal;
first measurement quantity information;
first event information;
first identifier information;
first transmission parameter information;
application layer configuration information; and
first configuration information.

Optionally, the representation information of the first information is indicated by information corresponding to a neutral network.

Optionally, the processor 510 is configured to: report the compressed first information according to a predefined cycle; or
trigger to report the compressed first information, according to a trigger condition, where
the trigger condition includes at least one of the following:
report indication information sent by a network is received;
a predefined event; and
an amount of the first information reaches a preset threshold.

Optionally, a report granularity of the first information includes at least one of the following:
each terminal;
each cell;
each frequency layer;
each BWP;
each transmit antenna port; and
each receive antenna port.

Optionally, the processor 510 is configured to:
compress the first information based on a first neural network; or
compress the first information based on a large-scale parameter; or
compress the first information by merging a plurality of parts of the first information; or
obtain statistical characteristics by performing mathematical operation on a plurality of parts of the first information, and report the statistical characteristics; or
compress the first information in a differential mode; or
compress the first information according to a category of the first information; or
compress the first information according to a priority of the first information; or
compress the first information according to an association relationship between at least two pieces of first information.

Optionally, the differential mode includes at least one of the following:
performing differentiation according to time;
performing differentiation according to a position; and
performing differentiation according to a target parameter, where the target parameter includes at least one of: a tracking area (TA), a frequency, a public land mobile network, connection information, and a quality of service flow (QOS Flow).

Optionally, the processor 510 is configured to:
obtain a category corresponding to each piece of the first information; and
select first information corresponding to a target category as the compressed first information.

Optionally, the processor 510 is configured to:
obtain a priority corresponding to each piece of the first information; and
select first information with a priority higher than a preset priority as the compressed first information.

Optionally, an association relationship exists between at least two information types in the following information of the first information reported by the terminal:
time information;
measurement result information;
position information;
event information; and
channel characteristic information.

Optionally, the first condition includes at least one of the following:
a first position condition;
a first measurement quantity condition;
a first event condition;
a first identifier condition;
a first transmission parameter condition;
an application layer related condition; and
a first configuration condition.

Optionally, the first position condition includes:
a position of the terminal meets a first preset condition.

Optionally, the position of the terminal includes at least one of the following:
a cell in which the terminal is located;
a tracking area (TA) in which the terminal is located;
a RAN-based notification area in which the terminal is located;
a geographic position of the terminal; and
a timing advance (TA) indicated by a network for the terminal.

Optionally, the first preset condition includes at least one of the following:
a specific representation of the terminal or the position of the terminal falls within a preconfigured range corresponding to a cell identifier;
a specific representation of the terminal or the position of the terminal falls within a preconfigured range corresponding to the tracking area;
a specific representation of the terminal or the position of the terminal falls within a preconfigured geographic position range;
a specific representation of the terminal or the position of the terminal falls within a preconfigured range corresponding to the RAN-based notification area (RNA); and
a specific representation of the terminal or the position of the terminal falls within a preconfigured range corresponding to the timing advance (TA).

Optionally, the first measurement quantity condition includes:
a first measurement quantity meets a second preset condition.

Optionally, the first measurement quantity includes at least one of the following:
a signal value obtained at a receiving reference point or a statistical value of the signal value, where the signal value or the statistical value includes a channel estimated value obtained on an RE;
a signal-to-noise ratio (SNR);
a reference signal received power (RSRP);
a signal-to-noise and interference ratio (SINR);
reference signal received quality (RSRQ);
a packet delay;
a round-trip time (RTT);
an observed time difference of arrival (OTDOA);
a measurement result corresponding to channel state information (CSI);
a measurement result of radio resource management (RRM) measurement;
a measurement result of beam failure detection (BFD) measurement;
a measurement result of radio link failure (RLF) measurement;
a measurement result corresponding to reference signal (RS) measurement;
quality of experience (QoE) measurement information, where the QoE measurement information includes at least one of: a packet loss rate, service delay information, and a throughput; and
image information or image perception information, where the image information or the image perception information includes at least one of: information obtained by a camera and information obtained by a sensor.

Optionally, the measurement result corresponding to the first measurement quantity is obtained based on single measurement, or the measurement result corresponding to the first measurement quantity is obtained based on measurement for a plurality of times.

Optionally, a measurement resource corresponding to the first measurement quantity is preconfigured or prescribed in advance, where
the measurement resource corresponding to the first measurement quantity includes at least one of the following:
a physical downlink control channel (PDCCH) demodulation reference signal (DMRS);
a physical downlink shared channel (PDSCH) DMRS;
a channel state information reference signal (CSI-RS);
a synchronization signal/physical broadcast channel signal block (SSB);
a reference signal for BFD;
a reference signal for RRM;
a reference signal for RLF;
an identifier corresponding to the reference signal for BFD;
an identifier corresponding to the reference signal for RRM; and
an identifier corresponding to the reference signal for RLF.

Optionally, the second preset condition includes at least one of the following:
the SNR or a specific representation of the SNR falls within a preconfigured range;
the RSRP or a specific representation of the RSRP falls within a preconfigured range;
the SINR or a specific representation of the SINR falls within a preconfigured range;
the RSRQ or a specific representation of the RSRQ falls within a preconfigured range;
the packet delay or a specific representation of the packet delay falls within a preconfigured range;
the RTT or a specific representation of the RTT falls within a preconfigured range;
the OTDOA or a specific representation of the OTDOA falls within a preconfigured range;
the measurement result corresponding to the CSI or a specific representation of the measurement result corresponding to the CSI falls within a preconfigured first measurement range;
the measurement result of the RRM measurement or a specific representation of the measurement result of the RRM measurement falls within a preconfigured range;
the measurement result of the BFD measurement or a specific representation of the measurement result of the BFD measurement falls within a preconfigured range;
the measurement result of the RLF measurement or a specific representation of the measurement result of the RLF measurement falls within a preconfigured range;
the measurement result corresponding to the RS measurement or a specific representation of the measurement result corresponding to the RS measurement falls within a preconfigured second measurement range; and
the measurement result corresponding to the QoE measurement information or a specific representation of the measurement result corresponding to the QoE measurement information falls within a preconfigured third measurement range.

Optionally, the radio resource management (RRM) measurement includes:
serving cell measurement;
neighboring cell measurement;
camping cell measurement; and
non-camping cell measurement.

Optionally, the first event condition includes:
a first event meets a third preset condition.

Optionally, the first event includes at least one of the following:
a beam failure recovery (BFR) event;
a radio link failure (RLF) event;
radio resource management (RRM) measurement;
a handover event;
a measurement result event corresponding to BFR;
a measurement result event corresponding to RLF; and
an event that triggers the RRM measurement.

Optionally, the third preset condition includes at least one of the following:
a measurement result corresponding to the BFR event or a specific representation corresponding to the BFR event falls within a preconfigured third measurement range;
a measurement result corresponding to the RLF event or a specific representation corresponding to the RLF event falls within a preconfigured fourth measurement range;
a measurement result corresponding to the RRM measurement or a specific representation corresponding to the RRM measurement falls within a preconfigured fifth measurement range; and
a measurement result corresponding to the handover event or a specific representation corresponding to the handover event falls within a preconfigured sixth measurement range.

Optionally, the measurement result corresponding to the BFR event or the specific representation corresponding to the BFR event includes at least one of the following:
a beam failure detection reference signal based measurement result in BFR;
a new beam based measurement result in BFR; and
a measurement result based on a BFR event occurrence frequency.

Optionally, the measurement result corresponding to the RLF event or the specific representation corresponding to the RLF event includes at least one of the following:
a serving cell based measurement result;
a neighboring cell based measurement result; and
a measurement result based on an RLF occurrence frequency.

Optionally, the measurement result corresponding to the RRM measurement or the specific representation corresponding to the RRM measurement includes at least one of the following:
a measurement result corresponding to the serving cell;
a measurement result corresponding to the neighboring cell;
a measurement result corresponding to the camping cell; and
a measurement result corresponding to the non-camping cell.

Optionally, the measurement result corresponding to the handover event or the specific representation corresponding to the handover event includes at least one of the following:
a TA corresponding to a source cell;
a TA corresponding to a target cell;
data interrupt duration;
a result of a difference between signal quality before handover and signal quality after handover;
a measurement quantity obtained in a handover process; and
a handover frequency.

Optionally, the first identifier condition includes:
a first identifier meets a fourth preset condition.

Optionally, the first identifier includes at least one of the following:
a cell identifier; and
a public land mobile network (PLMN) identifier.

Optionally, the fourth preset condition includes at least one of the following:
the cell identifier is an identifier in a preconfigured cell identifier list; and
the PLMN identifier is an identifier in a preconfigured PLMN identifier list.

Optionally, the first transmission parameter condition includes:
a first transmission parameter meets a fifth preset condition.

Optionally, the first transmission parameter includes at least one of the following:
a channel characteristic parameter;
phase information between different transmit antennas or different transmit ports;
a measurement parameter obtained on one or more beams;
information corresponding to different beam pairs, where the beam pair includes a transmit beam and a receive beam;
a measurement parameter obtained on one or more frequencies;
data demodulation soft information;
a bit error rate or block error rate of data packet transmission, where the data packet includes one or more of the following: a physical layer data packet, a MAC layer data packet, an RLC layer data packet, a PDCP layer data packet, and an IP layer data packet; and
interference measurement information.

Optionally, the fifth preset condition includes at least one of the following:
the channel characteristic parameter or a specific representation of the channel characteristic parameter falls within a preconfigured parameter range;
the beam measurement parameter or a specific representation of the beam measurement parameter falls within a preconfigured parameter range;
the phase information between different transmit antennas or different transmit ports or a specific representation of the phase information conforms to preconfigured phase information;
information corresponding to different receive beams or a specific representation of the information corresponding to different receive beams conforms to preconfigured first beam information;
the information corresponding to different beam pairs or a specific representation of the information corresponding to different beam pairs conforms to preconfigured second beam information;
the measurement parameter obtained on one or more frequencies falls within a preconfigured parameter range;
the data demodulation soft information or a specific representation of the data demodulation soft information conforms to preconfigured information;
the bit error rate of data packet transmission or a specific representation of the bit error rate of data packet transmission conforms to preconfigured information, where the data packet includes one or more of the following: a physical layer data packet, a MAC layer data packet, an RLC layer data packet, a PDCP layer data packet, and an IP layer data packet;
the block error rate or a specific representation of the block error rate conforms to preconfigured information; and
the interference measurement information or a specific representation of the interference measurement information conforms to preconfigured information.

Optionally, the application layer related condition includes:
the application layer configuration information meets a sixth preset condition.

Optionally, the first configuration condition includes:
a first configuration meets a seventh preset condition.

Optionally, the first configuration includes one or more of the following:
a configuration of reporting the specific first information; and
a configuration of content of the first information.

Optionally, the first condition further includes:
a manner of processing information corresponding to the first condition conforms to a preconfigured manner.

Optionally, the first condition is configured by a network or is prescribed in advance.

Optionally, the preset compression manner is configured by a network or is prescribed in advance.

Optionally, different second target information corresponds to different first conditions or different preset compression manners, and the second target information includes at least one of the following:
a cell;
a TA area;
a frequency;
a PLMN;
connection information;
a QoS flow; and
a bandwidth part (BWP).

Optionally, the processor is further configured to:
in a case of changing the second target information, change a corresponding first condition or preset compression manner.

Optionally, each piece of the second target information corresponds to at least one first condition or corresponds to at least one preset compression manner.

Optionally, configuration signaling of the first condition or the preset compression manner is the same as configuration signaling of the second target information.

Optionally, before compressing the first information in the preset compression manner, the processor is further configured to:
obtain first indication information, where the first indication information is used to indicate index information corresponding to at least one of: the first condition and the preset compression manner; and
determine, according to the first indication information, at least one of: the first condition and the preset compression manner that correspond to the first indication information.

In this embodiment of this application, the first information is compressed in the preset compression manner, and the compressed first information is reported. The first information is information related to training data. In this way, the first information related to the training data is compressed in the preset compression manner and then reported, so that overheads of air interface signaling can be reduced.

An embodiment of this application further provides a readable storage medium. The readable storage medium may be non-volatile or volatile. The readable storage medium stores a program or an instruction, and when the program or the instruction is executed by a processor, the processes of the foregoing embodiment of the information processing method are implemented, and a same technical effect can be achieved. To avoid repetition, details are not described herein again.

The processor is a processor in the terminal in the foregoing embodiment. The readable storage medium includes a computer-readable storage medium such as a computer read-only memory (ROM), a random access memory (RAM), a magnetic disk, a compact disc, or the like.

An embodiment of this application further provides a chip. The chip includes a processor and a communication interface, the communication interface is coupled to the processor, and the processor is configured to run a program or an instruction to implement the processes of the embodiment of the information processing method, and a same technical effect can be achieved. To avoid repetition, details are not described herein again.

It should be understood that the chip mentioned in this embodiment of this application may also be referred to as a system-level chip, a system chip, a chip system, or a system on chip.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. An element limited by “includes a . . . ” does not, without more constraints, preclude the presence of additional identical elements in the process, method, article, or apparatus that includes the element. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the related technology may be implemented in a form of a computer software product. The computer software product is stored in a storage medium (such as a ROM/RAM, a magnetic disk, or an optical disc), and includes several instructions for instructing a terminal (which may be a mobile phone, a computer, a server, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. An information processing method, comprising:
compressing, by a terminal, first information in a preset compression manner, and reporting compressed first information, wherein
the first information comprises at least one of the following:
first target information;
representation information of the first target information;
measurement information corresponding to the first target information;
neural network use information corresponding to the first target information;
information indicating whether the first target information meets a first condition; and
value information corresponding to the first target information, wherein
the first target information comprises at least one of the following:
position information of the terminal;
first measurement quantity information;
first event information;
first identifier information;
first transmission parameter information;
application layer configuration information; and
first configuration information.

2. The method according to claim 1, wherein the representation information of the first information is indicated by information corresponding to a neutral network.

3. The method according to claim 1, wherein the reporting compressed first information comprises:
reporting the compressed first information according to a predefined cycle; or
triggering to report the compressed first information, according to a trigger condition, wherein
the trigger condition comprises at least one of the following:
report indication information sent by a network is received;
a predefined event; and
an amount of the first information reaches a preset threshold.

4. The method according to claim 1, wherein a report granularity of the first information comprises at least one of the following:
each terminal;
each cell;
each frequency layer;
each BWP;
each transmit antenna port; and
each receive antenna port.

5. The method according to claim 1, wherein the compressing, by a terminal, first information in a preset compression manner comprises:
compressing, by the terminal, the first information based on a first neural network; or
compressing, by the terminal, the first information based on a large-scale parameter; or
compressing, by the terminal, the first information by merging a plurality of parts of the first information; or
obtaining, by the terminal, statistical characteristics by performing mathematical operation on a plurality of parts of the first information, and reporting the statistical characteristics; or
compressing, by the terminal, the first information in a differential mode; or
compressing, by the terminal, the first information according to a category of the first information; or
compressing, by the terminal, the first information according to a priority of the first information; or
compressing, by the terminal, the first information according to an association relationship between at least two pieces of first information.

6. The method according to claim 5, wherein the differential mode comprises at least one of the following:
performing differentiation according to time;
performing differentiation according to a position; and
performing differentiation according to a target parameter, wherein the target parameter comprises at least one of: a tracking area (TA), a frequency, a public land mobile network, connection information, and a quality of service flow (QOS Flow).

7. The method according to claim 5, wherein the compressing, by the terminal, the first information according to a category of the first information comprises:
obtaining a category corresponding to each piece of the first information; and
selecting first information corresponding to a target category as the compressed first information.

8. The method according to claim 5, wherein the compressing, by the terminal, the first information according to a priority of the first information comprises:
obtaining a priority corresponding to each piece of the first information; and
selecting first information with a priority higher than a preset priority as the compressed first information.

9. The method according to claim 5, wherein an association relationship exists between at least two information types in the following information of the first information reported by the terminal:
time information;
measurement result information;
position information;
event information; and
channel characteristic information.

10. The method according to claim 1, wherein different second target information corresponds to different first conditions or different preset compression manners, and the second target information comprises at least one of the following:
a cell;
a TA area;
a frequency;
a PLMN;
connection information;
a QoS flow; and
a bandwidth part (BWP).

11. The method according to claim 10, further comprising:
in a case of changing the second target information, changing a corresponding first condition or preset compression manner.

12. The method according to claim 10, wherein each piece of the second target information corresponds to at least one first condition or corresponds to at least one preset compression manner.

13. The method according to claim 10, wherein configuration signaling of the first condition or the preset compression manner is the same as configuration signaling of the second target information.

14. The method according to claim 1, wherein before the compressing, by a terminal, first information in a preset compression manner, the method further comprises:
obtaining first indication information, wherein the first indication information is used to indicate index information corresponding to at least one of: the first condition and the preset compression manner; and
determining, according to the first indication information, at least one of: the first condition and the preset compression manner that correspond to the first indication information.

15. A terminal, comprising: a processor, a memory, and a program or an instruction that is stored in the memory and that can run on the processor, wherein the program or instruction, when executed by the processor, causes the processor to perform:
compressing first information in a preset compression manner, and reporting compressed first information, wherein
the first information comprises at least one of the following:
first target information;
representation information of the first target information;
measurement information corresponding to the first target information;
neural network use information corresponding to the first target information;
information indicating whether the first target information meets a first condition; and
value information corresponding to the first target information, wherein
the first target information comprises at least one of the following:
position information of the terminal;
first measurement quantity information;
first event information;
first identifier information;
first transmission parameter information;
application layer configuration information; and
first configuration information.

16. The terminal according to claim 15, wherein the representation information of the first information is indicated by information corresponding to a neutral network.

17. The terminal according to claim 15, wherein the reporting compressed first information comprises:
reporting the compressed first information according to a predefined cycle; or
triggering to report the compressed first information, according to a trigger condition, wherein
the trigger condition comprises at least one of the following:
report indication information sent by a network is received;
a predefined event; and
an amount of the first information reaches a preset threshold.

18. The terminal according to claim 15, wherein a report granularity of the first information comprises at least one of the following:
each terminal;
each cell;
each frequency layer;
each BWP;
each transmit antenna port; and
each receive antenna port.

19. The terminal according to claim 15, wherein the compressing first information in a preset compression manner comprises:
compressing the first information based on a first neural network; or
compressing the first information based on a large-scale parameter; or
compressing the first information by merging a plurality of parts of the first information; or
obtaining statistical characteristics by performing mathematical operation on a plurality of parts of the first information, and reporting the statistical characteristics; or
compressing the first information in a differential mode; or
compressing the first information according to a category of the first information; or
compressing the first information according to a priority of the first information; or
compressing the first information according to an association relationship between at least two pieces of first information.

20. A non-transitory readable storage medium, wherein the non-transitory readable storage medium stores a program or an instruction, and wherein the program or instruction, when executed by the processor, causes the processor to perform:
compressing first information in a preset compression manner, and reporting compressed first information, wherein
the first information comprises at least one of the following:
first target information;
representation information of the first target information;
measurement information corresponding to the first target information;
neural network use information corresponding to the first target information;
information indicating whether the first target information meets a first condition; and
value information corresponding to the first target information, wherein
the first target information comprises at least one of the following:
position information of the terminal;
first measurement quantity information;
first event information;
first identifier information;
first transmission parameter information;
application layer configuration information; and
first configuration information.
